(19) United States
(12) Patent Application Publication
(10) Pub. No.: US 2020/0177814 A1
(43) Pub. Date: Jun. 4, 2020

(54) IMAGE CAPTURING APPARATUS AND METHOD OF CONTROLLING IMAGE CAPTURING APPARATUS

(71) Applicant: CANON KABUSHIKI KAISHA, Tokyo (JP)

(72) Inventor: Daisuke Enomoto, Yokohama-shi (JP)

(21) Appl. No.: 16/693,763

(22) Filed: Nov. 25, 2019

(30) Foreign Application Priority Data
Nov. 30, 2018 (JP) 2018-225485

(51) Int. Cl. H04N 5/232; H04N 5/235

(52) U.S. Cl. CPC H04N 5/23274; H04N 5/2353; H04N 5/23267; H04N 5/23258; H04N 5/2351

(57) ABSTRACT

An image capturing apparatus includes a first image sensor configured to output a first image signal based on light from a first image capturing optical system, a second image sensor configured to output a second image signal based on light from a second image capturing optical system, a determination unit configured to determine visibility of a region corresponding to a first image based on the first image signal in a second image based on the second image signal, a control unit configured to control the first image sensor to execute an image capturing operation in a case where the visibility of the region is low, an image processing unit configured to generate a third image signal by combining the first image signal with the second image signal, and a display control unit configured to control to display an image based on the third image signal on a display unit.

### BACKGROUND

### Field of the Disclosure

The present disclosure relates to an image capturing apparatus that includes a plurality of image sensors and a method of controlling the same.

### Description of the Related Art

Some conventional image capturing apparatuses have a function of user assistance in framing. In, especially, image capturing apparatuses that include a high-magnification zoom lens, an image capturing angle of view becomes so narrow during high-magnification zoom image capturing that a main subject can disappear from a live-view display before image capturing due to a camera tilt caused by a slight handshake or a slight movement of the main subject. A user operates the image capturing apparatus to recapture the main subject, which is outside the angle of view, in the image capturing angle of view. To assist the recapturing, some image capturing apparatuses include a plurality of image sensors to capture images at different angles of view. Japanese Patent Application Laid-Open No. 2012-147082 discusses an image capturing apparatus that assists framing by controlling an angle of view of a wide-angle image capturing optical system in a case where an angle of view of a telephoto optical system is changed, whereby the user can easily keep track of the main subject.

### SUMMARY

According to an aspect of the present disclosure, an image capturing apparatus includes a first image sensor configured to output a first image signal based on light from a first image capturing optical system, a second image sensor configured to output a second image signal based on light from a second image capturing optical system, and at least one processor or circuit which functions as a display control unit configured to control a display of a first image based on the first image signal and a second image based on the second image signal, a determination unit configured to determine visibility of a region corresponding to the first image in the second image signal acquired at a second angle of view wider than a first angle of view which is an angle of view of the first image, an image capturing control unit configured to cause the first image sensor to execute an image capturing operation in a case where the determination unit determines that the visibility of the region corresponding to the first image is low, and an image processing unit configured to generate a third image signal by combining the first image signal with the second image signal in a case where the first image sensor executes the image capturing operation during image capturing preparation, wherein the display control unit performs control to display an image based on the third image signal on a display unit.

Other aspects of the present disclosure will be specified in the below-described exemplary embodiments.

Further features of the present disclosure will become apparent from the following description of exemplary embodiments with reference to the attached drawings.

### BRIEF DESCRIPTION OF THE DRAWINGS

FIG. 1 is a block diagram illustrating a configuration of an image capturing apparatus according to an exemplary embodiment of the present disclosure.

FIG. 2 is a flowchart illustrating an example of a framing assistance control operation according to a first exemplary embodiment.

FIG. 3 is a diagram including flowcharts of FIGS. 3A and 3B illustrating an example of a framing assistance control operation according to a second exemplary embodiment.

FIG. 4 is a diagram including flowcharts of FIGS. 4A and 4B illustrating an example of a framing assistance control operation according to a third exemplary embodiment.

FIG. 5 is a flowchart illustrating an example of a framing assistance control operation according to a fourth exemplary embodiment.

FIG. 6 is a flowchart illustrating an example of a framing assistance control operation according to a fifth exemplary embodiment.

FIG. 7A is a diagram illustrating an example of an image displayed on a display unit according to an exemplary embodiment of the present disclosure. FIG. 7B is a diagram illustrating another example of an image displayed on the display unit according to an exemplary embodiment of the present disclosure.

### DESCRIPTION OF THE EMBODIMENTS

As described above, the image capturing apparatus discussed in Japanese Patent Application Laid-Open No. 2012-147082 assists framing by allowing a user to easily keep track of a main subject. However, simultaneous image capturing operations by a plurality of image sensors increase power consumption. In exemplary embodiments described below, an image capturing apparatus that includes a plurality of image sensors and is capable of assisting a user in framing while preventing an increase in power consumption will be described together with a method of controlling the image capturing apparatus.

An image capturing apparatus that stops an image capturing operation of a telephoto image capturing unit during a live view (during image capturing preparation) to reduce power consumption will be described below. If the visibility of a region corresponding to an image acquired by the telephoto image capturing unit in an image captured by a wide-angle image capturing unit is low, the image capturing operation of the telephoto image capturing unit is also executed so that user convenience increases. If an image capturing instruction is received, the image capturing operation of the telephoto image capturing unit is started so that an image captured at a telephoto angle of view is acquired.

Various exemplary embodiments of the present disclosure will be described below with reference to the drawings.

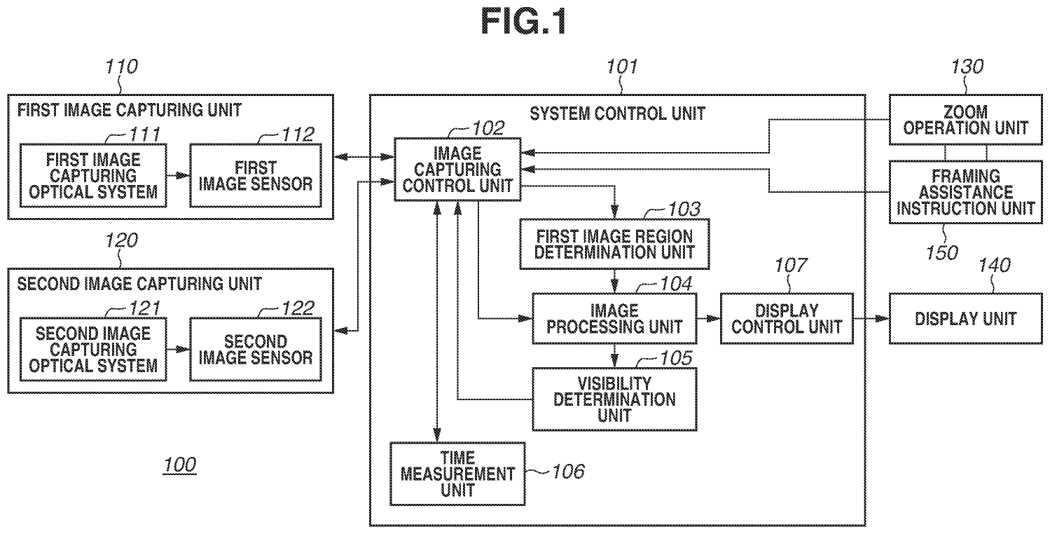

FIG. 1 is a diagram illustrating an example of a configuration of an image capturing apparatus 100 according to a first exemplary embodiment.

As illustrated in FIG. 1, the image capturing apparatus 100 includes a system control unit 101, a first image capturing unit 110, a second image capturing unit 120, a zoom operation unit 130, a display unit 140, and a framing assistance instruction unit 150.

The first image capturing unit 110 includes a first image capturing optical system 111 and a first image sensor 112. The first image capturing optical system 111 includes an optical element and can optically change a zoom ratio of a subject image, i.e., focal length. The focal length can be changed by, for example, changing the position of a zoom lens in an optical axis direction. The first image capturing optical system 111 can change the focal length regardless of an operation state (image capturing state or stopped state) of the first image sensor 112.

The first image sensor 112 photoelectrically converts a subject image input via the first image capturing optical system 111 to a digital video signal and outputs the digital video signal as a first image signal to an image capturing control unit 102 of the system control unit 101. In the present specification, the operation from the photoelectrical conversion to the image signal output is referred to as “image capturing operation”. The image capturing operation by the first image sensor 112 is executed based on an image capturing operation instruction from the image capturing control unit 102.

The second image capturing unit 120 includes a second image capturing optical system 121 and a second image sensor 122. The second image capturing optical system 121 can perform image capturing at an angle wider than an angle of a wide-angle end of the first image capturing optical system 111. The second image capturing optical system 121 includes an optical element, but the second image capturing optical system 121 according to the present exemplary embodiment is a single-focus optical system and has a shorter focal length than a focal length of the wide-angle end of the first image capturing optical system 111.

The second image sensor 122 photoelectrically converts a subject image input via the second image capturing optical system 121 to a digital video signal and outputs the digital video signal as a second image signal to the image capturing control unit 102. The image capturing operation by the second image sensor 122 is executed also based on an image capturing operation instruction from the image capturing control unit 102.

The relative positional relationship between an optical axis of the first image capturing optical system 111 and an optical axis of the second image capturing optical system 121 is fixed. The position and size of a region of the first image captured by the first image capturing unit 110 in the second image captured by the second image capturing unit 120 can be acquired based on the relative positions of the optical axes of the first and second image capturing optical systems 111 and 112 and the relationship between the focal lengths of the first and second image capturing optical systems 111 and 112.

The zoom operation unit 130 is an operation member configured to change the focal length of the first image capturing optical system 111. When the zoom operation unit 130 is operated, the image capturing control unit 102 controls the position of the zoom lens of the first image capturing optical system 111 so that the focal length of the first image capturing optical system 111 is changed. In an image capturing executable state, if the user operates the zoom operation unit 130, the focal length is changed as needed to prepare for subject-image capturing. In a case where the first image capturing unit 110 includes an electronic zoom function, a zoom ratio is changed while the focal length of the first image capturing optical system 111 remains the same, but in the present application, an electronic zoom is converted to a focal length and the converted focal length is used. For example, when the focal length is 100 mm and an electronic zoom ratio is twofold, the focal length is determined to be 200 mm and the determined focal length is used.

The display unit 140 receives a display video signal generated by predetermined signal processing which is performed by the system control unit 101 on the image signals acquired by the first and second image capturing units 110 and 120, and performs monitor displaying. The display unit 140 performs the monitor displaying during image capturing preparation (before a release button is pressed) to provide a live view function with which the user performs framing.

Next, a functional configuration of the system control unit 101 will be described below.

As illustrated in FIG. 1, the system control unit 101 includes the image capturing control unit 102, a first image region determination unit 103, an image processing unit 104, a visibility determination unit 105, a time measurement unit 106, and a display control unit 107.

The image capturing control unit 102 controls the optical elements of the first and second image capturing optical systems 111 and 121 and controls the image capturing operations of the first and second image sensors 112 and 122 to thereby control the image capturing processing of the first image capturing unit 110 and the second image capturing unit 120.

The image capturing control unit 102 controls the position of the zoom lens of the first image capturing optical system 111 to adjust the focal length of the first image capturing optical system 111 to a focal length specified by the zoom operation unit 130. In addition, the image capturing control unit 102 outputs information about a current angle of view of the first image capturing optical system 111 to the first image region determination unit 103. The information about an angle of view can be any information from which the angle of view is unambiguously acquired, and the angle of view can be used directly as the information, or information such as the focal length, zoom ratio, or zoom lens position. The change of the focal length and the output of the information about the angle of view are executed as needed when a user operation of the zoom operation unit 130 is received.

The image capturing control unit 102 also changes the image capturing operation state of the first image capturing unit 110 from the image capturing state to the image capturing stopped state or from the image capturing stopped state to the image capturing state during image capturing preparation based on a result of a determination by the visibility determination unit 105. In the image capturing stopped state, the supply of power and a control signal, such as a clock, to the first image sensor 112 is stopped at least partially, and the power consumption is lower than that in the image capturing state. Details of the control will be described below. The image capturing state during image capturing preparation refers to a live-view image capturing state.

The image capturing control unit 102 also outputs the first image signal captured by the first image capturing unit 110 and the second image signal captured by the second image capturing unit 120 to the image processing unit 104.

In a case where the user operates an image capturing execution instruction member (so-called release button) (not illustrated) to input an instruction to execute image capturing, the image capturing control unit 102 causes the first image capturing unit 110 to execute an image capturing operation, and a captured still image or captured moving image data is recorded in a recording unit (not illustrated).

The first image region determination unit 103 determines the position and size of a region (also referred to simply as “first image region”) corresponding to the first image in the second image. The size of the region corresponding to the first image is acquired from the current relationship between the focal lengths of the first and second image capturing optical systems 111 and 121. For example, if a condition other than the focal lengths is the same, and when the focal length of the first image capturing optical system 111 is tenfold longer than the focal length of the second image capturing optical system 121, the horizontal and vertical sizes of the region corresponding to the first image in the second image are both one-tenth an entire region of the second image. The position of a center of the region corresponding to the first image is determined based on the relative positions of the first and second image capturing optical systems 111 and 121. Since the relative positions are fixed in the present exemplary embodiment, the position of the center of the region corresponding to the first image in the second image is fixed. The information about the position of the center and the focal length of the second image capturing optical system 121 can be recorded in the recording unit (not illustrated). In this case, the first image region determination unit 103 reads the information about the position of the center and the information about the angle of view of the second image capturing optical system 121 from the recording unit. Then, the region corresponding to the first image in the second image is determined based on the read information and the information about the angle of view of the first image capturing optical system 111 that is received from the image capturing control unit 102. The information about the angle of view of the second image capturing optical system 121 can also be acquired from the image capturing control unit 102 similarly to the acquisition of the information about the angle of view of the first image capturing optical system 111.

The first image region determination unit 103 outputs the information about the determined position and size of a first angle of view to the image processing unit 104.

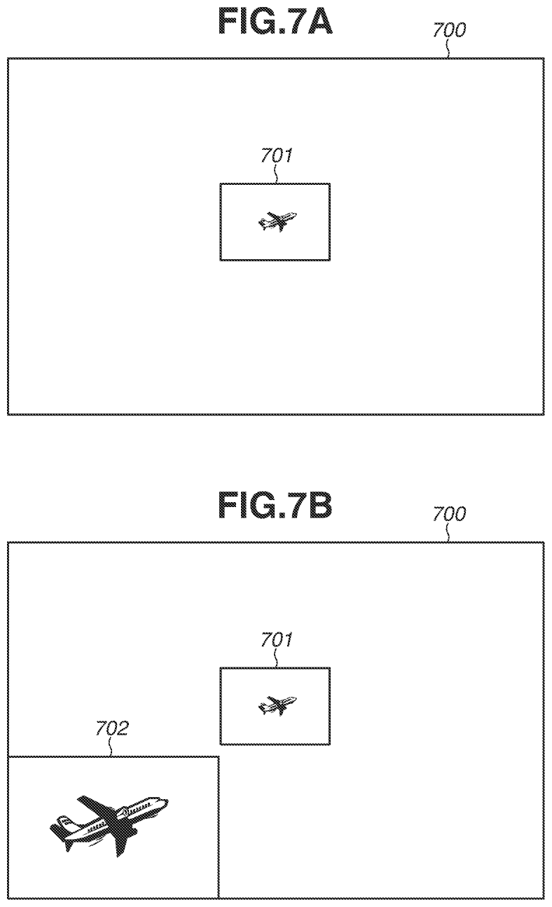

The image processing unit 104 performs predetermined signal processing on the images input from the image capturing control unit 102 to generate a display video signal and outputs the display video signal to the display control unit 107. FIGS. 7A and 7B are diagrams illustrating an example of an image displayed on the display unit 140 based on the display video signal. The image processing unit 104 combines the second image signal input from the image capturing control unit 102 with a frame (i.e., an outline of the region corresponding to the first image) 701, which indicates the position and size of the first angle of view input from the first image region determination unit 103, to generate a display video signal. An image based on the generated display video signal is illustrated in FIG. 7A. An image generated by combining a second image 700, which is based on the second image signal, with the frame 701 is displayed.

Further, the image processing unit 104 can generate a display video signal by combining the first image signal with a portion of the second image signal input from the image capturing control unit 102. An image based on the generated display video signal is illustrated in FIG. 7B. An image generated by combining the second image 700, which is based on the second image signal, with the frame 701 and a first image 702, which is based on the first image signal, is displayed.

Further, the image processing unit 104 outputs a result of a comparison between an exposure evaluation value calculated using the entire region of the second image input from the image capturing control unit 102 as an evaluation region and an exposure evaluation value calculated using the region corresponding to the first image in the second image as an evaluation region to the visibility determination unit 105. Examples of a value that can be used as an exposure evaluation value include the number or ratio of pixels not having gradation information (overexposure, underexposure) and a mode value, mean value, or median value of an image luminance (brightness) histogram. The image processing unit 104 can also compare the exposure evaluation values by acquiring at least one of the difference or ratio between the exposure evaluation value of the entire region of the second image and the exposure evaluation value of the region corresponding to the first image.

Based on the result of the comparison between the exposure evaluation values that is input from the image processing unit 104, the visibility determination unit 105 determines whether the visibility of the region corresponding to the first image is low, and outputs a result of the determination to the image capturing control unit 102. In a case where the result (difference or ratio) of the comparison between the exposure evaluation values is greater than or equal to a predetermined value, the visibility determination unit 105 determines that the visibility is low, whereas if the result is smaller than the predetermined value, the visibility determination unit 105 determines that the visibility is high.

The time measurement unit 106 measures a duration time of the image capturing operation state of the first image capturing unit 110 from a timing at which the image capturing control unit 102 starts the image capturing operation state of the first image capturing unit 110. If the time measurement unit 106 detects that the duration time of the image capturing operation state, which is a measurement result, becomes or exceeds a predetermined time, the time measurement unit 106 outputs an image capturing operation duration time passage signal to the image capturing control unit 102.

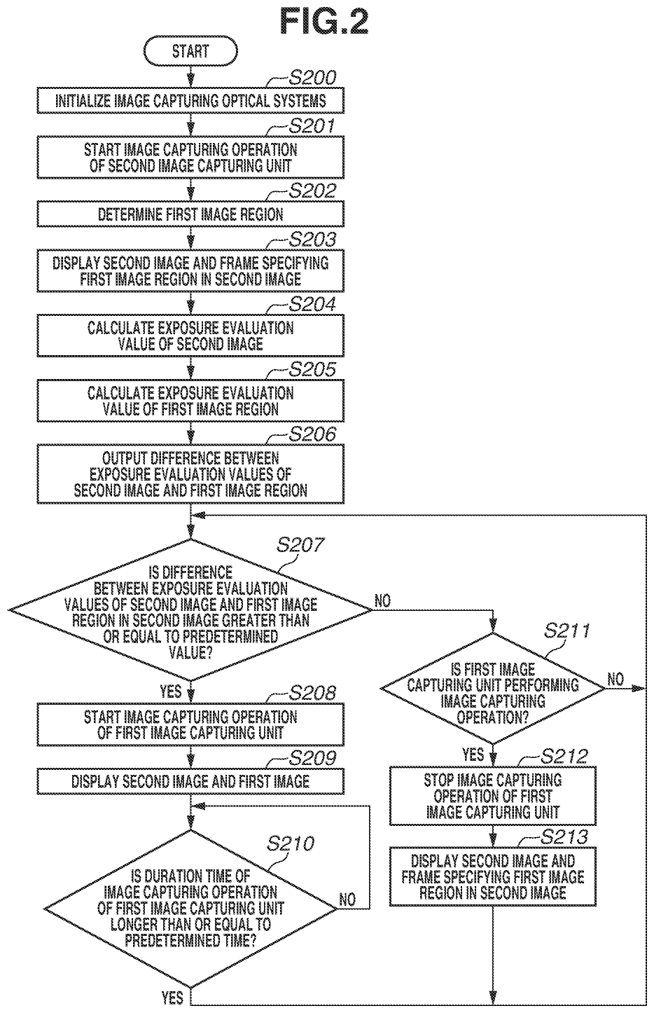

Next, operation control of the image capturing apparatus 100 according to the present exemplary embodiment will be described below. FIG. 2 is a flowchart illustrating an example of a framing assistance control operation during a live view of the image capturing apparatus 100 according to the present exemplary embodiment. The processing illustrated in FIG. 2 is performed by the system control unit 101. If an image capturing instruction is input, the steps are stopped, and the image capturing operation by the first image sensor 112 is started. In the image capturing operation, an image is captured with an exposure time determined by auto-exposure (AE) processing, and an acquired image signal is recorded in a recording medium. The user can input an image capturing instruction by pressing a shutter button (not illustrated), or in an automatic image capturing mode, the system control unit 101 can automatically generate an image capturing instruction and inputs the image capturing instruction to the image capturing control unit 102.

The flowchart illustrated in FIG. 2 is executed if power is supplied to the image capturing apparatus 100 and preparation processing for changing the image capturing apparatus 100 to the image capturing executable state is started.

First, in step S200, the image capturing control unit 102 sets each of the first and second image capturing optical systems 111 and 121 to an initial state. Specifically, the image capturing control unit 102 controls the position of each lens included in the first and second image capturing optical systems 111 and 121 to place the lens to an initial position.

Next, in step S201, the image capturing control unit 102 outputs predetermined power and a control signal, such as a clock, to the second image sensor 122 of the second image capturing unit 120, so that the second image sensor 122 starts the image capturing operation.

In step S202, the first image region determination unit 103 determines the position and size of the region corresponding to the first image in the second image corresponding to the second image signal based on information about the focal length of each of the first and second image capturing optical systems 111 and 121.

In step S203, the image processing unit 104 generates a display video signal by combining the second image signal input from the image capturing control unit 102 with the frame 701, which is input from the first image region determination unit 103 and indicates the position and size of the region corresponding to the first image, and outputs the generated display video signal to the display control unit 107. The display control unit 107 outputs the display video signal to the display unit 140 so that an image based on a monitor display signal is displayed on the display unit 140.

In step S204, the image processing unit 104 calculates an exposure evaluation value using the entire region of the second image captured by the second image capturing unit 120 as an evaluation region. The use of the entire region of the second image as an evaluation region is not limited to the use of all image signals of the entire region of the second image, and the image signals that are thinned can be used, or only some of the image signals can be used. At least a portion of a region of the second image other than the region corresponding to the first image in the second image is to be used.

In step S205, the image processing unit 104 calculates an exposure evaluation value using the region corresponding to the first image in the second image as an evaluation region.

In step S206, the image processing unit 104 calculates the difference between the exposure evaluation value of the second image and the exposure evaluation value of the region corresponding to the first image in the second image and outputs a result of the calculation to the visibility determination unit 105. In a case where a ratio is used as an exposure evaluation value comparison result, a ratio is calculated and the calculated ratio is output.

In step S207, the visibility determination unit 105 determines whether the difference between the exposure evaluation values that is input from the image processing unit 104 is greater than or equal to a predetermined value (i.e., whether an exposure level of the region corresponding to the first image is an appropriate level). In a case where the visibility determination unit 105 determines that the difference between the exposure evaluation values is greater than or equal to the predetermined value (YES in step S207), the exposure level of the region corresponding to the first image may not be an appropriate level even if the exposure level of the entire region of the second image is an appropriate level, so that the processing proceeds to step S208.

In step S208, the image capturing control unit 102 supplies necessary power and a control signal, such as a clock, to the first image sensor 112 of the first image capturing unit 110 so that the image capturing operation of the first image sensor 112 is started. The image capturing control unit 102 notifies the time measurement unit 106 that the image capturing operation of the first image sensor 112 is started.

In step S209, the image processing unit 104 generates a display video signal that the user can refer to during framing, by combining the first image with a portion of the second image as illustrated in FIG. 7B, for example, and outputs the generated display video signal to the display control unit 107. The display control unit 107 displays an image based on the display video signal on the display unit 140. Through steps S208 and S209, the first image capturing unit 110 acquires the first image signal with an appropriate exposure for the first image, and an image generated by combining the acquired first image signal with the second image signal is displayed. In this way, the first and second images with high visibility are displayed even in a case where the exposure level of the region corresponding to the first image in the second image is not an appropriate level.

In step S210, in a case where an image capturing operation duration time passage signal is input from the time measurement unit 106 to the image capturing control unit 102 (YES in step S210), the processing returns to step S207, and the determination of whether the visibility is low is performed again.

Meanwhile, in step S207, in a case where the visibility determination unit 105 determines that the difference between the exposure evaluation values that is input from the image processing unit 104 is smaller than the predetermined value (NO in step S207), the processing proceeds to step S211, and the image capturing operation of the first image capturing unit 110 is stopped or the stopped state of the first image capturing unit 110 is continued.

In step S211, in a case where the first image capturing unit 110 does not perform the image capturing operation (NO in step S211), the processing returns to step S207, and the determination of whether the visibility is low is performed again. In a case where the determination results in steps S207 and S211 are both “NO”, the visibility determination is repeated until one of the determination results in steps S207 and S211 becomes “YES” or until an image capturing instruction is input.

In a case where the first image capturing unit 110 performs the image capturing operation (YES in step S211), then in step S212, the image capturing control unit 102 stops supply of necessary power and the control signal such as a clock to the first image sensor 112 of the first image capturing unit 110 and stops the image capturing operation. In this way, the image capturing operation state of the first image capturing unit 110 is changed from the image capturing state to the image capturing stopped state. In this process, the image capturing control unit 102 notifies the time measurement unit 106 that the image capturing operation of the first image capturing unit 110 is stopped.

In step S213, the image processing unit 104 generates a display video signal by combining the second image 700 input from the image capturing control unit 102 with the frame 701, which indicates the outline of the region corresponding to the first image, and outputs the generated display video signal to the display control unit 107. The display control unit 107 displays an image based on the display video signal on the display unit 140.

As described above, in the present exemplary embodiment, the image capturing operation of the first image sensor 112 is actively stopped during framing. Furthermore, the second image captured by the second image capturing unit 120, which captures a wider-angle image, and the frame that indicates the outline of the region corresponding to the first image that is recorded during image capturing are live-view displayed on the display unit 140.

According to the present exemplary embodiment, a frequency of disappearance of a main subject from a live-view display on the display unit 140 is reduced even in image capturing in which the zoom ratio of the first image capturing optical system 111 is set to a high ratio. Furthermore, since the image capturing operation of the first image capturing unit 110 is stopped, the power consumption is reduced compared to a conventional technique in which a plurality of image capturing units is simultaneously operated regardless of the visibility of the region corresponding to the first image.

According to the present exemplary embodiment, a decrease in visibility of the region corresponding to the first image on the live-view display is automatically determined, and in a case where it is determined that the visibility is low, the image capturing operation of the first image capturing unit 110 is automatically started and a captured image based on the first image signal is added to the live-view display.

In this way, a decrease in framing operability due to a decrease in visibility of a subject in the region corresponding to the first image is reduced so that the assistance of the user in framing improves.

Next, an example of an image capturing apparatus according to a second exemplary embodiment of the present disclosure will be described below. In the first exemplary embodiment, the framing assistance operation is started if power is supplied to the image capturing apparatus 100 and the image capturing preparation processing is started. In the present exemplary embodiment, a configuration in which the framing assistance instruction unit 150 is included so that the user can manually change a framing assistance function between “ON” and “OFF” states and the image capturing control unit 102 performs an assistance operation based on an instruction from the framing assistance instruction unit 150 will be described below.

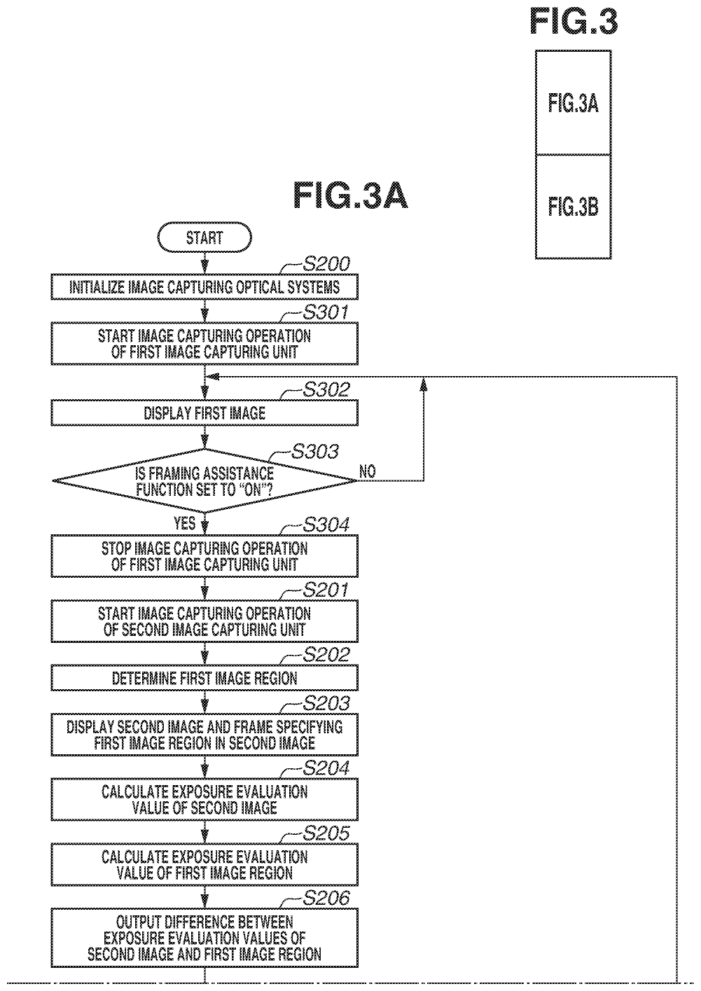

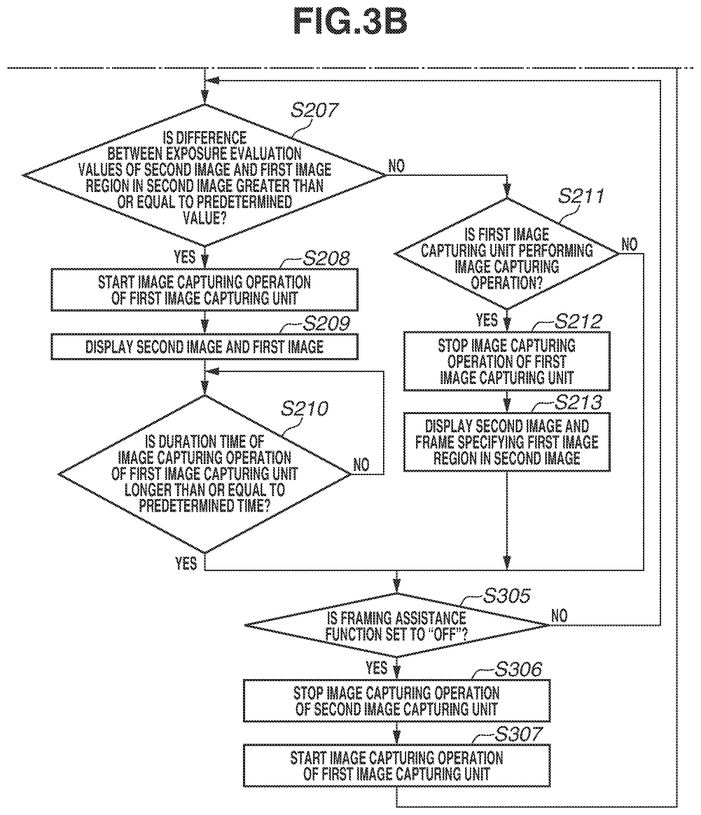

A configuration of the image capturing apparatus 100 according to the present exemplary embodiment is similar to that in the first exemplary embodiment, so that description thereof is omitted. FIG. 3 is a diagram including flowcharts of FIGS. 3A and 3B illustrating the present exemplary embodiment. In the flowchart illustrated in FIG. 3, each process similar to that in FIG. 2 is given the same reference numeral, and description thereof is omitted.

After step S200 is performed, in step S301, the image capturing control unit 102 outputs predetermined power and a control signal, such as a clock, to the first image sensor 112 of the first image capturing unit 110 so that a first image capturing operation is started.

In step S302, the image processing unit 104 generates a display video signal that the user refers to during framing based on the first image signal, and outputs the generated display video signal to the display unit 140 via the display control unit 107. In this process, the second image signal is not combined with the display video signal, and the image capturing apparatus 100 is in an image capturing preparation state in which so-called normal live-view displaying is performed.

In step S303, the image capturing control unit 102 determines whether the framing assistance function is set to the “ON” state by the framing assistance instruction unit 150. In a case where the framing assistance function is set to the “OFF” state by the framing assistance instruction unit 150 (NO in step S303), the processing returns to step S302, and the live-view display based on the first image signal is continued until the framing assistance function is set to the “ON” state. Meanwhile, in a case where the framing assistance function is set to the “ON” state by the framing assistance instruction unit 150 (YES in step S303), the processing proceeds to step S304.

In step S304, the image capturing control unit 102 stops the supply of necessary power and a control signal such as a clock to the first image sensor 112 of the first image capturing unit 110 and stops the image capturing operation. After the image capturing operation by the first image capturing unit 110 is stopped, the processing proceeds to step S201, and processing similar to that in step S201 in the first exemplary embodiment is performed. The order of steps S304 and S201 may be reversed.

Step S201 and the subsequent steps are basically similar to those in the first exemplary embodiment, except for step S305 in which whether the framing assistance function is set to the “ON” state is determined before the processing returns from step S210, S211, or S213 to step S207 in which the determination of the difference between the evaluation values is performed again.

In a case where the framing assistance function is set to the “OFF” state by the framing assistance instruction unit 150 (YES in step S305), the processing proceeds to step S306. In step S306, the image capturing control unit 102 stops the image capturing operation of the second image capturing unit 120. Meanwhile, in a case where the framing assistance function is set to the “ON” state by the framing assistance instruction unit 150 (NO in step S305), the processing returns to step S207.

In step S306, the image capturing operation of the second image capturing unit 120 is stopped, then in step S307, the image capturing control unit 102 causes the first image capturing unit 110 to start the image capturing operation, and the processing returns to step S302.

With the above-described configuration, the user can choose to stop the framing assistance function when the possibility of frame out is low, e.g., when the image capturing apparatus 100 is fixed to a tripod and captures a telephoto image of a still subject, even during image capturing with a high-magnification zoom.

An example of an image capturing apparatus according to a third exemplary embodiment of the present disclosure will be described below. In the first exemplary embodiment, the example of the framing assistance operation in the case where the second image capturing optical system 121 has a shorter focal length than the wide-angle end of the first image capturing optical system 111 is described. In the present exemplary embodiment, the second image capturing optical system 121 having a focal length between the wide-angle end and a telephoto end of the first image capturing optical system 111 will be described below. In the present exemplary embodiment, the framing assistance control is performed in a case where the first image capturing optical system 111 has a narrower angle of view than that of the second image capturing optical system 121.

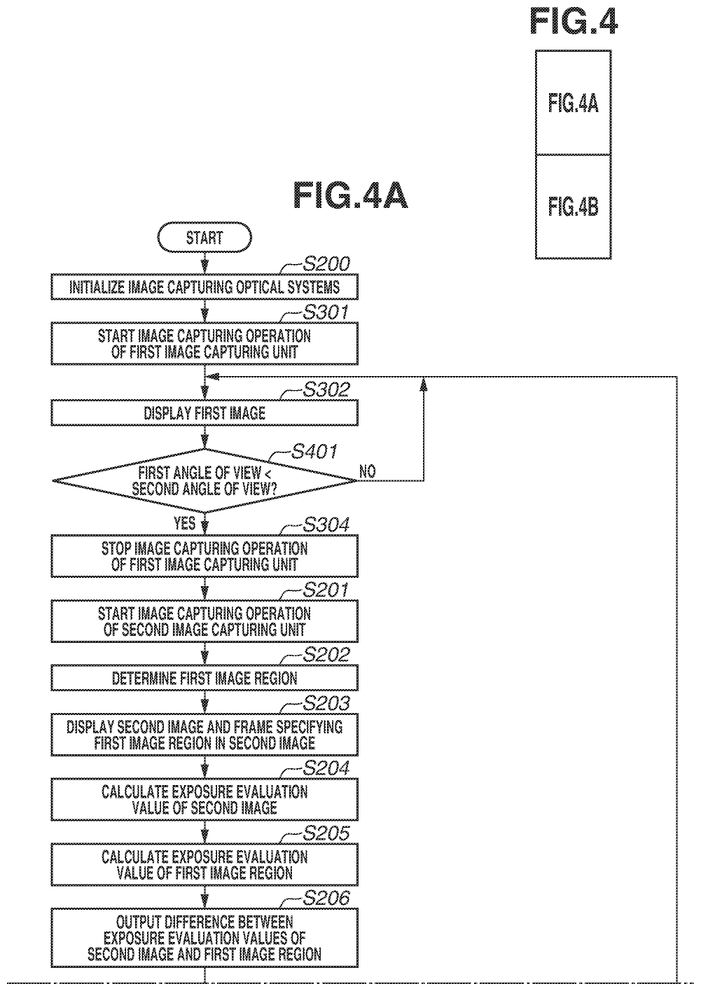

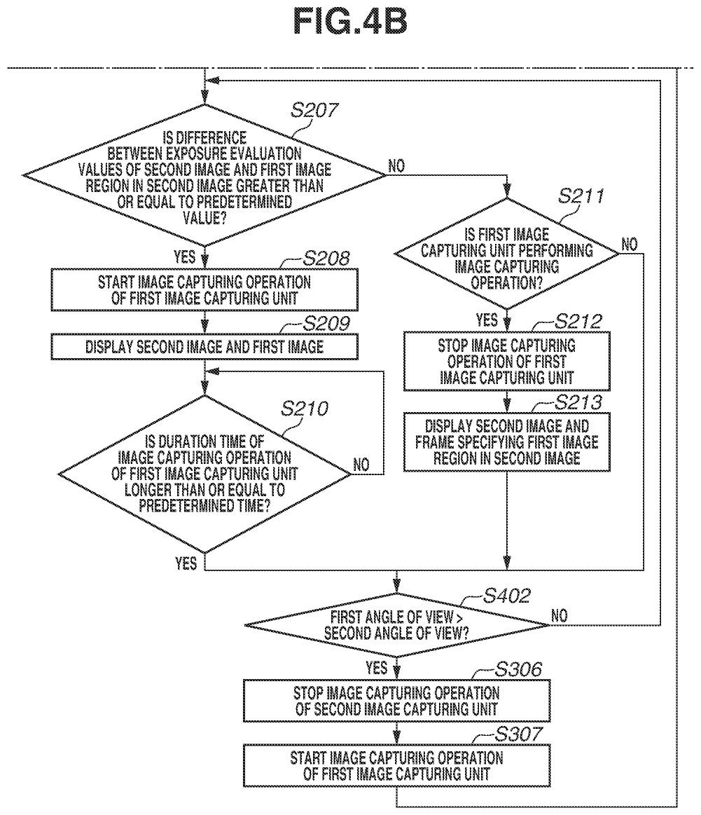

A configuration of the image capturing apparatus 100 according to the present exemplary embodiment is similar to that in the first exemplary embodiment, so that description thereof is omitted. FIG. 4 is a diagram including flowcharts of FIGS. 4A and 4B illustrating a framing assistance control operation according to the present exemplary embodiment.

In the flowchart illustrated in FIG. 4, each process similar to that in FIGS. 2 and 3 is given the same reference numeral, and description thereof is omitted.

As in the second exemplary embodiment, the processes to step S302 are performed.

In step S401, the image capturing control unit 102 determines whether the first angle of view to be captured by the first image capturing unit 110 is narrower than a second angle of view to be captured by the second image capturing unit 120 based on current focal length information about the first image capturing optical system 111 and focal length information about the second image capturing optical system 121.

In a case where the first angle of view is set to an angle of view wider than the second angle of view to be captured by the second image capturing unit 120 based on an instruction to change the zoom ratio from the zoom operation unit 130 (NO in step S401), the processing returns to step S302.

Meanwhile, in a case where the zoom operation unit 130 sets the first angle of view to an angle of view narrower than the second angle of view to be captured by the second image capturing unit 120 (YES in step S401), the processing proceeds to step S304.

The framing assistance operation in step S201 and the subsequent processes in the present exemplary embodiment are basically similar to step S201 and the subsequent processes in the first exemplary embodiment, except for step S402 in which whether the first angle of view is narrower than the second angle of view is determined before the processing proceeds from step S210, S211, or S213 to step S207 in which whether the difference between the evaluation values is greater than or equal to the predetermined value is determined.

In a case where the zoom operation unit 130 sets the first angle of view to an angle of view wider than the second angle of view (YES in step S402), the processing proceeds to step S306. In step S306, the image capturing control unit 102 stops the image capturing operation of the second image capturing unit 120.

Meanwhile, in a case where the zoom operation unit 130 sets the first angle of view to an angle of view narrower than the second angle of view (NO in step S402), the processing returns to step S207.

If the image capturing operation of the second image capturing unit 120 is stopped in step S306, then in step S307, the image capturing control unit 102 causes the first image capturing unit 110 to start the image capturing operation, and the processing proceeds to step S302.

With the above-described configuration, the framing assistance function is automatically enabled only during high-magnification image capturing in which the zoom ratio of the first image capturing optical system 111 is set to a relatively high ratio (specifically an angle narrower than that of the second image capturing optical system 121). While the framing assistance function is enabled in a case where the first angle of view is wider than the second angle of view in the present exemplary embodiment, the framing assistance function can be enabled in a case where the first angle of view is wider at least by a predetermined value than the second angle of view. For example, the framing assistance function may be enabled in a case where the first angle of view is 0.5 times the second angle of view or less.

An example of an image capturing apparatus according to a fourth exemplary embodiment of the present disclosure will be described below.

In a case where the zoom ratio of the first image capturing optical system 111 is set to a predetermined magnification or more, the difference between the second angle of view, which is the image capturing angle of view of the second image capturing optical system 121, and the first angle of view increases, and the frame that indicates the first angle of view on the live view display becomes smaller, so that the main subject becomes difficult to visually recognize. In the present exemplary embodiment, the framing assistance in the above-described case will be described.

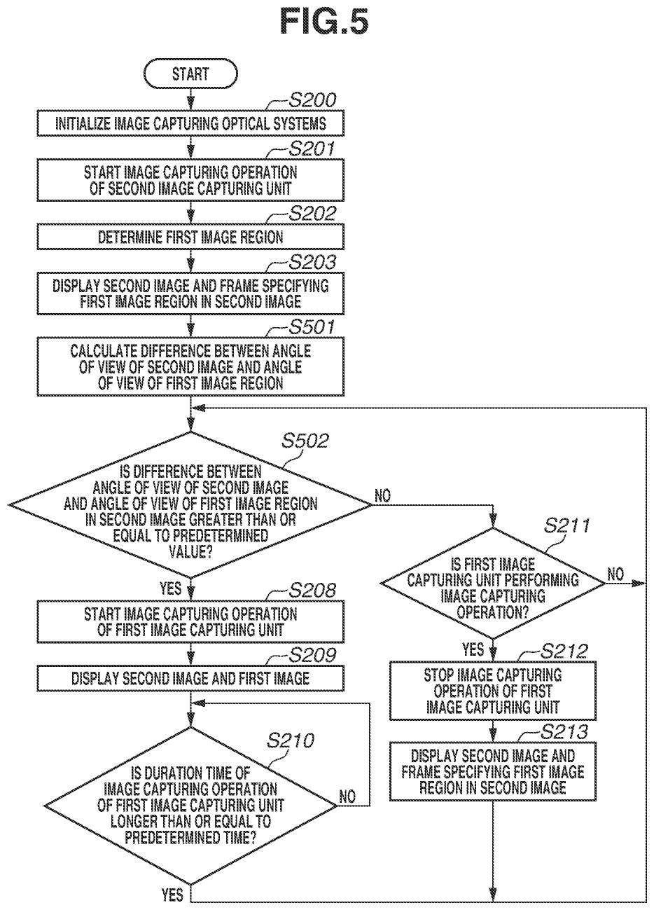

FIG. 5 is a flowchart illustrating an example of a framing assistance control operation according to the present exemplary embodiment. In the flowchart illustrated in FIG. 5, each process similar to that in FIG. 2 is given the same reference numeral, and description thereof is omitted.

As described above with reference to FIG. 2, after performing steps S200 to S203, in step S501, the image processing unit 104 calculates the difference between angles of view based on information about the angle of view of the second image and information about the first angle of view in the second image, and outputs the calculated difference to the visibility determination unit 105. In place of the difference between the angles of view, the ratio between the angles of view can be used. A value that corresponds to the ratio or difference between the angles of view can be also used in place of the difference between the angles of view. For example, the ratio or difference between the focal lengths or the ratio or difference between the zoom ratios based on the wide-angle end of the first image capturing optical system 111 can be used.

In step S502, the visibility determination unit 105 determines whether the difference between the angles of view that is calculated by the image processing unit 104 is greater than or equal to a predetermined value (i.e., whether the subject in the first image region is difficult to visually recognize).

In a case where the difference between the angles of view is greater than or equal to the predetermined value (YES in step S502), then in step S208, the image capturing control unit 102 causes the first image sensor 112 of the first image capturing unit 110 to start the first image capturing operation and notifies an operation duration time measurement unit that the first image capturing operation is started. Meanwhile, in a case where the visibility determination unit 105 determines that the difference between the angles of view that is calculated by the image processing unit 104 is smaller than the predetermined value (NO in step S502), the processing proceeds to step S211.

As described above, in the case where the difference between the second angle of view and the first angle of view is greater than or equal to the predetermined value, the visibility determination unit 105 determines that the visibility is decreased, and the image capturing operation of the first image capturing unit 110 is automatically started and the first image is added to the live view display image. In this way, a decrease in framing operability due to a decrease in visibility of the subject in the first image region is reduced, whereby the user assistance in framing can be realized.

An example of an image capturing apparatus according to a fifth exemplary embodiment of the present disclosure will be described below.

A configuration of the image capturing apparatus 100 according to the present exemplary embodiment is similar to that of the image capturing apparatus 100 according to the first exemplary embodiment, so that description thereof is omitted. In the present exemplary embodiment, the framing assistance in a case where a user performs an operation to designate a main subject (face of person, object) using the operation member, such as a touch panel, and the image processing unit 104 performs subject recognition processing on the first image region to assist framing will be described below.

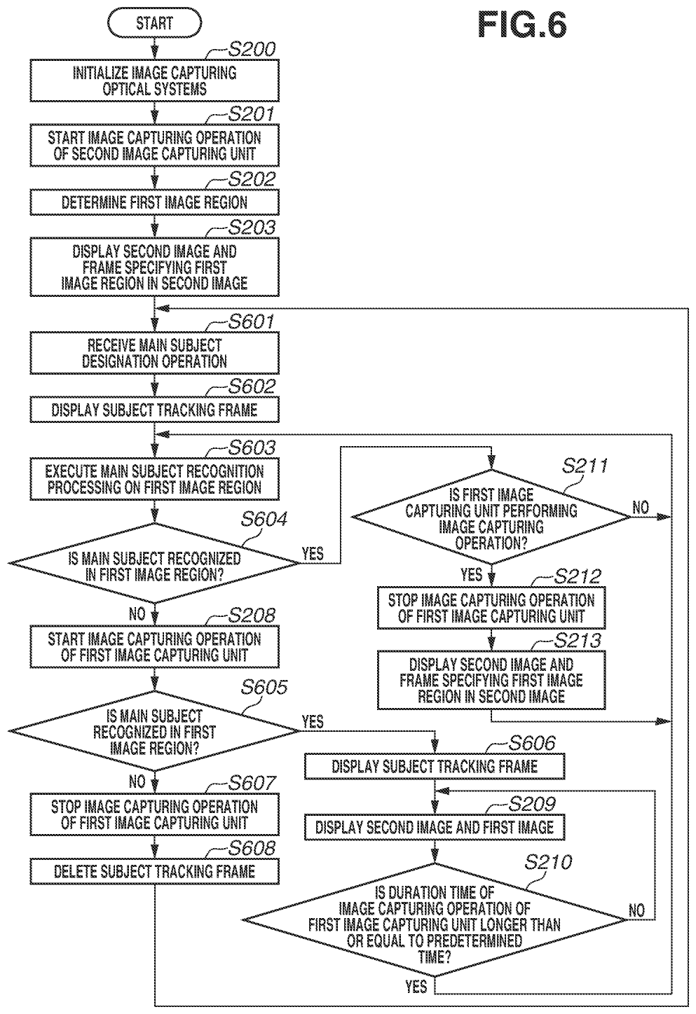

FIG. 6 is a flowchart illustrating an example of a framing assistance control operation according to the present exemplary embodiment. In the flowchart illustrated in FIG. 6, each step similar to that in FIG. 2 is given the same reference numeral, and description thereof is omitted.

As described above with reference to FIG. 2, after steps S200 to S203 are performed, in step S601, the image capturing apparatus 100 receives a user operation of designating a main subject via the operation member (not illustrated), such as a touch panel.

In step S602, the image processing unit 104 generates a display video signal by combining the display video signal generated in step S203 with a frame (referred to as “subject tracking frame”) surrounding the main subject designated in step S601, and outputs the generated display video signal to the display unit 140 via the display control unit 107.

In step S603, the image processing unit 104 executes main subject recognition processing with respect to the first image region in the second image to detect the main subject, and outputs a result about whether the main subject is recognized to the visibility determination unit 105.

In step S604, the visibility determination unit 105 determines the visibility of the main subject in the second image based on the result that is input from the image processing unit 104 and specifies whether the main subject is recognized. In a case where the main subject is not recognized in step S603 (NO in step S604), in step S208, the image capturing control unit 102 causes the first image sensor 112 to start the first image capturing operation and notifies the operation duration time measurement unit that the first image capturing operation is started. On the other hand, in a case where the main subject is recognized in step S603 (YES in step S604), the processing proceeds to step S211, and if the first image sensor 112 of the first image capturing unit 110 is performing the image capturing operation, then in step S212, the image capturing operation is stopped.

If the first image sensor 112 is caused to start the first image capturing operation in step S208, then in S605, the image processing unit 104 executes main subject recognition processing with respect to the first image to detect the main subject, and outputs a result about whether the main subject is recognized to the visibility determination unit 105.

In step S605, the visibility determination unit 105 determines the visibility of the main subject in the first image based on the result that is input from the image processing unit 104 and specifies whether the main subject is recognized.

In a case where the image processing unit 104 does not recognize the main subject (NO in step S605), in step S607, the image capturing control unit 102 stops the first image capturing operation of the first image sensor 112.

Thereafter, in step S608, the image capturing control unit 102 erases the subject tracking frame from the display video signal generated in step S602 to generate a display video signal, and outputs the generated display video signal to the display unit 140, so that the subject tracking frame is erased. The processing returns to S601, and the image capturing control unit 102 waits for a user operation of designating a main subject.

Meanwhile, in a case where the image processing unit 104 recognizes the main subject (YES in step S605), the processing proceeds to step S606. In step S606, a subject tracking frame is displayed as in step S602, and the processing proceeds to step S209. In step S209, an image generated by combining the first image with a portion of the second image is displayed. Steps S209 and S210 are similar to those in the first exemplary embodiment. The image displayed at this time is an image generated by adding the tracking frame to the image generated by combining the first image with the second image, and the tracking frame is combined in place of the frame 701, which indicates the outline of the first image region in FIG. 7B. While new subject recognition is not performed until the duration time of the image capturing operation of the first image capturing unit 110 becomes or exceeds the predetermined time in the flowchart illustrated in FIG. 6, in a case where the main subject is not recognized in the second image but is recognized in the first image, the subject recognition processing can be performed periodically on the first image. Auto-focus (AF)/AE processing is periodically performed with respect to the main subject based on the result of the periodically-performed subject recognition processing so that the image capturing can be performed without performing new AF/AE processing after an image capturing instruction is input.

In the present exemplary embodiment, as described above, the visibility determination unit 105 determines that the visibility is decreased in a case where the main subject designated by the user is not recognized in the first image region in the second image. Then, the image capturing operation of the first image capturing unit 110 is automatically started, and the main subject recognition processing is executed on the first image. In this way, a decrease in framing operability due to a decrease in visibility of the subject in the first angle-of-view region is reduced and therefore user assistance in framing can be realized.

While, according to the present exemplary embodiment, it is determined that visibility is decreased in a case where the user-designated main subject is not recognized in the first image region and the operation of the first image capturing unit 110 is started, the present disclosure is not limited to the example.

For example, in a case where the face of a person designated by the user is to be captured, processing of detecting a face region in the first image region using a publicly-known algorithm is performed. In this process, a feature amount of the face that is prepared in advance is compared with a feature amount extracted from a divided region on the first image region, and a region that a correlation value of the feature amount is greater than a predetermined threshold value is recognized as a face region. The correlation value of the feature amount can be used as an index, and in a case where the correlation value acquired in the first image region is decreased and becomes smaller than or equal to a predetermined threshold value, it is determined that the visibility of the first image region is decreased. In this way, the face detection processing on the first image is executed before tracking of the face of the designated person is completely lost in the first image region. Thus, the possibility that the subject tracking frame presented to the user is erased and decrease in the framing operability is reduced.

In the first to fifth exemplary embodiments described above, the first and second image sensors 112 and 122 output digital video signals as the first and the second image signals. Alternatively, the first and second image sensors 112 and 122 can output analog signals, and in a subsequent unit, e.g., the system control unit 101, the input analog signals may be converted to digital signals.

In the first to fifth exemplary embodiments described above, the focal length of the second image capturing optical system 121 is fixed. However, if the focal length of the second image capturing optical system 121 is shorter than the focal length of the first image capturing optical system 111, the second image capturing unit 120 can assist framing Thus, the focal length of the second image capturing optical system 121 can be variable in a case where the focal length of the second image capturing optical system 121 is set to be shorter than the telephoto end of the first image capturing optical system 111.

In the first to fifth exemplary embodiments, the visibility of the region corresponding to the first image is determined based on the exposure evaluation values, based on the difference between the angles of view, or based on whether the subject is recognized. The visibility determination method, however, is not limited to those described above and can be any method by which the visibility in the first image region can be determined.

For example, a shake detection unit configured to detect a shake of the image capturing apparatus 100 and a correction unit configured to correct a blur in the first image captured by the first image capturing unit 110 can be included, and in a case where the amount of detected shake is greater than or equal to a predetermined value, it is determined that the visibility of the first image region is decreased. The correction unit is included in the first image capturing unit 110 and corrects a shake by controlling movement of at least one of the optical element of the first image capturing optical system 111 and the first image sensor 112 on a plane that is perpendicular to the optical axis of the first image capturing optical system 111. With this configuration, decrease in framing operability due to decrease in visibility of the subject in the first image region that is caused by a handshake is reduced and therefore user assistance in framing in a case where the user holds a camera and captures an image in a dark scene such as a night scene can be realized.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority form Japanese Patent Application No. 2018-225485, filed Nov. 30, 2018, which is hereby incorporated by reference herein in its entirety.

What is claimed is:

1. An image capturing apparatus comprising:
a first image sensor configured to output a first image signal based on light from a first image capturing optical system;
a second image sensor configured to output a second image signal based on light from a second image capturing optical system; and
at least one processor or circuit which functions as:
a display control unit configured to control a display of a first image based on the first image signal and a second image based on the second image signal;
a determination unit configured to determine visibility of a region corresponding to the first image in the second image acquired at a second angle of view wider than a first angle of view which is an angle of view of the first image;
an image capturing control unit configured to cause the first image sensor to execute an image capturing operation in a case where the determination unit determines that the visibility of the region corresponding to the first image is low; and
an image processing unit configured to generate a third image signal by combining the first image signal with the second image signal in a case where the first image sensor executes the image capturing operation during image capturing preparation,
wherein the display control unit performs control to display an image based on the third image signal on a display unit.

2. The image capturing apparatus according to claim 1, wherein the determination unit determines the visibility of the region corresponding to the first image based on a result of a comparison between an exposure evaluation value of the region corresponding to the first image and an exposure evaluation value of the second image.

3. The image capturing apparatus according to claim 2, wherein the exposure evaluation value is at least one of information about a pixel that has lost gradation information and information about luminance, in each of the region corresponding to the first image and the second image.

4. The image capturing apparatus according to claim 2, wherein the result of the comparison is at least one of a difference and ratio between the exposure evaluation value of the region corresponding to the first image and the exposure evaluation value of the second image.

5. The image capturing apparatus according to claim 4, wherein the determination unit determines that the visibility of the region corresponding to the first image is low in a case where the difference between the exposure evaluation value of the region corresponding to the first image and the exposure evaluation value of the second image is greater than or equal to a predetermined value.

6. The image capturing apparatus according to claim 4, wherein the determination unit determines that the visibility of the region corresponding to the first image is low in a case where the ratio between the exposure evaluation value of the region corresponding to the first image and the exposure evaluation value of the second image is greater than or equal to a predetermined value.

7. The image capturing apparatus according to claim 1, wherein the determination unit determines the visibility of the region corresponding to the first image based on at least one of a difference and ratio between the first angle of view and the second angle of view.

8. The image capturing apparatus according to claim 7, wherein the determination unit determines that the visibility of the region corresponding to the first image is low in a case where the difference between the first angle of view and the second angle of view is greater than or equal to a predetermined value.

9. The image capturing apparatus according to claim 7, wherein the determination unit determines that the visibility of the region corresponding to the first image is low in a case where the ratio between the first angle of view and the second angle of view is greater than or equal to a predetermined value.

10. The image capturing apparatus according to claim 1,
wherein the image processing unit performs subject recognition processing with respect to a region corresponding to the first image, and
wherein the determination unit determines the visibility of the region corresponding to the first image based on a result of the recognition processing by the image processing unit.

11. The image capturing apparatus according to claim 1, further comprising:
a shake detection unit configured to detect a shake of the image capturing apparatus; and
a correction unit configured to correct a blur in the first image that is caused by the shake,
wherein the determination unit determines that the visibility of the region corresponding to the first image is low in a case where an amount of the shake detected by the shake detection unit is greater than or equal to a predetermined value.

12. The image capturing apparatus according to claim 11, wherein the correction unit controls moving of an optical element of the first image capturing optical system or the first image sensor on a plane that is perpendicular to an optical axis of the first image capturing optical system.

13. The image capturing apparatus according to claim 1, wherein the image capturing control unit includes a time measurement unit configured to measure a duration time of the image capturing operation of the first image sensor from a timing at which the image capturing operation is started, and the image capturing control unit performs control so that the image capturing operation is continued until the duration time becomes or exceeds a predetermined time.

14. The image capturing apparatus according to claim 1, further comprising a region determination unit configured to determine the region corresponding to the first image in the second image signal acquired at the second angle of view, based on information about the first angle of view and information about the second angle of view.

15. The image capturing apparatus according to claim 14,
wherein the information about the first angle of view is at least one of the information about the first angle of view, information about a focal length of the first image capturing optical system corresponding to the first angle of view, information about a zoom ratio of the first image, and information about a position of a zoom lens of the first image capturing optical system, and
wherein the information about the second angle of view is at least one of the information about the second angle of view, information about a focal length of the second image capturing optical system corresponding to the second angle of view, information about a zoom ratio of the second image, and information about a position of a zoom lens of the second image capturing optical system.

16. The image capturing apparatus according to claim 14, wherein the region determination unit determines the region corresponding to the first image in the second image signal acquired at the second angle of view based on the information about the first angle of view, the information about the second angle of view, and information about a relative position between the first image capturing optical system and the second image capturing optical system.

17. The image capturing apparatus according to claim 1, further comprising an operation unit configured to change a focal length of the first image capturing optical system.

18. A method of controlling an image capturing apparatus, the method comprising:
executing a first image capturing operation of a first image sensor configured to output a first image signal based on light from a first image capturing optical system;
executing a second image capturing operation of a second image sensor configured to output a second image signal based on light from a second image capturing optical system;
controlling a display of a first image based on the first image signal and a second image based on the second image signal;
determining visibility of a region corresponding to the first image in the second image acquired at a second angle of view wider than a first angle of view which is an angle of view of the first image;
causing the first image sensor to execute an image capturing operation in a case where the determining determines that the visibility of the region corresponding to the first image is low; and
generating a third image signal by combining the first image signal with the second image signal in a case where the first image sensor executes the image capturing operation during image capturing preparation,
wherein the controlling performs control to display an image based on the third image signal on a display unit.
